(19) United States
(12) Patent Application Publication
(10) Pub. No.: US 2008/0162718 A1
(43) Pub. Date: Jul. 3, 2008

(54) Method and Apparatus for Transmitting Data in Blocks

(76) Inventor: Yongmin Zhang, Guangdong (CN)

Correspondence Address: BYIP, LTD., P.O. BOX 1484, GENERAL POST OFFICE, HONG KONG, omitted

(21) Appl. No.: 12/063,029

(22) PCT Filed: Jul. 31, 2006
(86) PCT No.: PCT/CN2006/001902

§ 371 Date: Feb. 6, 2008

(30) Foreign Application Priority Data
Aug. 9, 2005 (CN) 200510021479.8

(51) Int. Cl. G06F 15/173

(52) U.S. Cl. 709/236

(57) ABSTRACT

A method for transmitting data in blocks includes steps: the source for transmitting data monitors the connection and disconnection request of clients for receiving data continually, establishes a control data set for the clients that request transmitting the same content, and the control data set includes the communication data of clients and the sign indicating the change of the control data set. The source classifies the clients joining the control data set into M groups, there is at least one client in each group and the client number in each group is nearly equal, where M is a natural number larger than or equal to 1. The source transmits the control data set to the clients. The source divides the content requested by the clients into data blocks to the M groups clients. The M groups clients exchange the data blocks each other according to the control data set, and combine the integrated content. The present invention has fast speed, high network utilization ratio and better security.

### FIELD OF THE INVENTION

The present invention relates to a method and a device for data transmission via network, and particularly to a method and a device for data block transmission.

### BACKGROUND OF THE INVENTION

During the data transmission via network, a real-time content source or a stored content file has to be decomposed into many packets In the transmission. The network is dynamic, and routes selected by each packet are not exactly the same. Therefore, the packets arrive at a client with a different time delay, and a data packet transmitted earlier may even arrive later. Therefore, a cache system is used to mitigate the influence of delay and jitter and guarantee a correct sequence of the data packets, so that medium data can be outputted continuously, and there will be no pause during playing that is resulted from temporary network congestion. The capacity needed by a high-speed cache is usually not large, because a ring linked list structure is used in the high-speed cache to store data: By throwing away the content already being played, a stream can reuse the emptied high-speed cache space to cache the subsequent content not yet played.

For a traditional unicast transmission method, a strong participation of a server is needed for data transmission. The content source or the file is uploaded to a certain particular website, and a user searches for the desired content source or file at a certain website and then downloads. The inconveniences of this method are obvious. One of stream-oriented transmission methods is unicast transmission, where an individual data channel is required for a source and each of the clients. By this communication method, a source IP host sends a data packet toward an appointed target IP host, each of the data packets sent from the source can only be transferred to one of the clients, and the source has to send an individual data packet copy toward each of the clients desiring to receive this data packet. This great redundancy will result in a very high expense. First, it will result in a heavy load to the source host sending the data because the source host has to respond to every request, which greatly prolongs response of the host; second, a higher requirement is put forward for performance of a router and an exchange, and a manager has to purchase hardware and bandwidth that are originally not necessary to guarantee certain service quality, which is an important shortcoming of the unicast transmission. At present, the appearance of P2P (peer to peer, peer-to-peer interaction or point-to-point technology) makes the conversation possible from server to server, server to PC, PC to PC, and PC to WAP mobile phone. It is not necessary for all the data to be downloaded from a central server. A real-time contact can be established between any two PCs on the Internet. Such a safe and shared virtual space can be established that people can perform various activities, which can be carried out either at the same time or interactively.

Compared with the common network file transmission, streaming media transmission is characterized by a large data volume, strong time-delay sensitivity, a long duration, etc. Though having various technologies, P2P all has the following weaknesses during the streaming media transmission: A poor real-time property, difficult to be controlled, and difficult to get a balance between integrity and transmission speed of the data.

### SUMMARY OF THE INVENTION

A main purpose of the present invention is to provide a method and a device for the data block transmission with good real-time property, fast transmission speed, high network utilization factor, and high safety, so as to resolve the problems with the prior art.

A second purpose of the present invention is to provide a method and a device for the data block transmission that can make the transmission speed faster, so as to resolve the problems with the prior art.

A further purpose of the present invention is to provide a data block transmission method that can guarantee integrity and safety of the data transmission, so as to resolve the problems with the prior art.

In order to realize the above-mentioned purposes, the present invention provides a data block transmission method comprising:

A1. monitoring connection request and disconnection of a client that is waiting for receiving the data, and establishing a control data set for the clients that request transferring the same content, said control data set including the data necessary for mutual communication between all the clients and marks reflecting change of the control data set;

B1. dividing the clients added into the control data set into M groups, each of said groups including at least one client, and the number of the clients in each group being made equal as far as possible, said M being a natural number equal to 1 or bigger than 1;

C1. sending the control data set to the client;

D1. dividing the content the client requests to transfer into the data blocks, and transferring the data blocks to the M-group clients, respectively; and

E1. composing the integral content according to the data block exchange between the control data sets by the M-group clients.

The above-mentioned M can be changed with change of the connection number of the client. The change of M does not affect execution of the above-mentioned steps, because in Step C1 the control data set including all the clients will be updated before transmission of a content block. It can be agreed upon that M is not bigger than a preset value. It can also be agreed upon that the connection number of the client is not bigger than a preset value; when the connection number of the client is bigger than the preset value, a new connection of the client is rejected or switched to another transmission of the same content.

Specially, further comprising: when finding the client is requesting connection or disconnection, changing the control data set, re-marking the control data set, and transferring the changed control data set to the connected client. wherein the changed control data set is marked according to its sequence of change.

Each of the clients in the above-mentioned control data set can depend on communication between the control data sets.

It can be determined in Step C1 that only when the client is connected or the control data set is changed will the source transfer to the client the control data set before or after transformation, so as to reduce the data transmission volume.

The content block transmission as mentioned in Step D1 comprises:

D11. dividing the content to be transferred into the blocks with a proper length;

D12. adding extra-information to the data block, and assembling the packets before being placed in a buffer area to wait for transmission, said extra-information including content mark, block number, time slice and check sum; and

D13. taking out M content packets from the buffer area each time, marking the M content packets with the group numbers in one-to-one correspondence with the M groups, and then transferring the M content packets to all the clients in each of the groups according to the group number.

The time slice and the check sum in the above-mentioned D12 can have a null value.

A further improvement of the present invention is, said data exchange between the M-group clients in Step E1 comprises: after receiving the content packet, actively forwarding the received content packet to a client in correspondence with it in a different group according to the client group in the latest control data set and the communication data of the client, and not forwarding the content packet when the client in correspondence with which in a different group is null; or the receiving the content packet, actively forwarding the received content packet to a client of another group in a distribution-tree way according to the client group in the latest control data set and the communication data of the client. Therefore, collaborative transmission is realized for all the clients, making the transferred content possess the real-time property.

A further improvement of the present invention is, further comprising the packet resupplying step: not receiving the content packet in the time-out period of an agreed receiving time, sending a packet resupplying request to a certain client of the same group by the client waiting for the content packet according to the latest control data set, to require the client to resupply the missed content packet. Therefore, a quality-of-service (QoS) guarantee mechanism is realized.

Some packet resupplying measures are still needed after the failure in requesting a certain client of the same group to resupply the packet. For example, request other clients or the source to resupply the packet until success, or treat it as a packet missing issue after trying a certain number of times or period of time.

When there is a low requirement for the real-time property, the request of the client for resupplying a certain content packet is not limited to the current, and it can also be responsible for resupplying the content packet the client had in the past.

In order to realize the above-mentioned purposes, the present invention further provides a data block transmission device, the device comprising:

connection/disconnection request unit adapted to monitor connection request and disconnection of the client waiting for receiving the data;

control data set establishing unit adapted to establish a control data set for the client that requests transferring the same content, the control data set including the data necessary for mutual communication between all the clients and marks reflecting change of the control data set, the control data set being updated according to connection/disconnection information of the client monitored by the connection/disconnection request unit;

control data set storage unit adapted to store the control data set;

grouping unit adapted to divide the clients added into the control data set into M groups, there being at least one client in each of the groups, the number of the clients in each group being made equal as far as possible, M being a natural number equal to 1 or bigger than 1;

blocking unit adapted to divide the content a client requests to transfer into many data blocks, and assembling the packets before the packets are placed in the buffer area to wait for transmission;

reading unit adapted to read the M data packets from the buffer area according to the number of groups, M, of the clients in the latest control data set;

data packet processing unit adapted to divide the M packets into M groups, the M packets being marked with the group numbers in one-to-one correspondence with the M groups; and

data sending unit adapted to correspondingly transfer the M content packets according to the group number to each of the M-group clients, respectively, according to the data necessary for mutual communication between the clients in the latest control data set, and further for transferring the control data set to each of the clients connected with the source.

A still further improvement of the present invention is, further comprising control data set compare unit and control data set change storage unit, said control data set compare unit being adapted to comparing the current control data set with a certain previous control data set and storing the changed part in the control data set change storage unit.

In order to realize the above-mentioned purposes, the present invention further provides a data block transmission system, including a content source and a client. said source comprising:

connection/disconnection request unit adapted to monitor connection request and disconnection of the client waiting for receiving the data;

control data set establishing unit adapted to establish a control data set for the client that requests transferring the same content, the control data set including the data necessary for mutual communication between all the clients and marks reflecting change of the control data set, the control data set being updated according to connection/disconnection information of the client monitored by the connection/disconnection request unit;

control data set storage unit adapted to store the control data set;

grouping unit adapted to divide the clients added into the control data set into M groups, there being at least one client in each of the groups, the number of the clients in each group being made equal as far as possible, M being a natural number equal to 1 or bigger than 1;

blocking unit adapted to divide the content a client requests to transfer into many data blocks, and assembling the packets before the packets are placed in the buffer area to wait for transmission;

reading unit adapted to read the M data packets from the buffer area according to the number of groups, M, of the clients in the latest control data set; data packet processing unit adapted to divide the M packets into M groups, the M packets being marked with the group numbers in one-to-one correspondence with the M groups; and

data sending unit adapted to correspondingly transferring the M content packets according to the group number to each of the M-group clients, respectively, according to the data necessary for mutual communication between the clients in the latest control data set, and further for transferring the control data set to each of the clients connected with the source;

said client comprising:

connection request unit adapted to send the connection request of the transferred content to the source;

data receiving unit adapted to receive the data from the source or other clients, the data including the content requested to be transferred and the control data set;

control data set storage unit adapted to store the control data set; and

data sending unit adapted to forward the content packet received by the group to a corresponding member of other groups according to the group the client belongs to and the members, in accordance with the latest control data set.

wherein said source further comprises control data set compare unit and control data set change storage unit, said control data set compare unit being adapted to compare the current control data set with a certain previous control data set, and store the changed part in the control data set change storage unit;

said client further comprises content packet buffer pool, marking unit, control unit and storage unit, said content packet buffer pool being adapted to temporarily store the content packet the client has received in a queue manner, said control unit being adapted to detect the location where the content packet is placed in the receiving buffer pool, said marking unit being adapted to make a having-received mark at a corresponding position and record the position in the receiving buffer pool; and whenever a position is marked, the control unit will check the content packet mark table in the marking unit, judge whether the received content packet is continuous, and store the continuous content packet to the storage unit or use it.

In order to realize the above-mentioned purposes, the present invention further provides a computer-readable medium with a computer-executable program. The program can realize the following functions through execution of the source computer for sending data:

monitoring connection request and disconnection of the client waiting for receiving the data continuously, and establishing a control data set for the clients that request transferring the same content, said control data set including the data necessary for mutual communication between all the clients and marks reflecting change of the control data set;

dividing the clients added into the control data set into M groups, each of said groups including at least one client, and the number of the clients in each group being made equal as far as possible, said M being a natural number equal to 1 or bigger than 1;

sending the control data set to the client; and

dividing the content a client requests to transfer into the data blocks, and transferring the data blocks to the M-group clients, respectively;

the program can realize the following function through execution of the client computer:

composing the integral content according to the data block exchange between the control data sets after receiving the data block by the M-group clients.

Another further improvement of the present invention is as below: The program can further realize the following functions through execution of the source computer:

dividing the content to be transferred into the blocks with a proper length;

adding extra-information to the data block, and assembling the packets before being placed in a buffer area to wait for transmission, said extra-information including content mark, block number, time slice and checksum; and

taking out M content packets from the buffer area each time, marking the M content packets with the group numbers in one-to-one correspondence with the M groups, and then transferring the M content packets to all the clients in each of the groups according to the group number.

The program can further realize the following functions through execution of the client computer:

after receiving the content packet, actively forwarding the received content packet to a client in correspondence with it in a different group according to the client group in the latest control data set and the communication data of the client, and not forwarding the content packet when the client in correspondence with which in a different group is null; or

the receiving the content packet, actively forwarding the received content packet to a client of another group in a distribution-tree way according to the client group in the latest control data set and the communication data of the client.

The program can still further realize the following function through execution of the client computer: not receiving the content packet in the time-out period of an agreed receiving time, sending a packet resupplying request to a certain client of the same group by the client waiting for the content packet according to the latest control data set, to require the client to resupply the missed content packet.

The present invention has the following beneficial effects: 1) The source establishes the control data set according to the number of the clients requesting the transferred content, divides the clients into some groups, divides the content needed to be transferred according to the number of groups of the clients, and transfers to all the members of each group, respectively, and the clients of different groups mutually transfer the received data blocks. Therefore, it can be prevented that all the clients download the entire content from the source (the network bandwidth required by the source by this method is only 1/M of that by the C/S method), easing the network congestion, improving the network utilization, and increasing transmission speed and download speed. Because the transmission is accomplished according to the real-time and the latest control data set, the data can be reasonably arranged to be transferred reasonably, safely and reliably. 2) The data block transmission between clients of different groups is accomplished in an active transmission way, and collaborative transmission is thus realized for all the clients, further increasing transmission speed of the data. 3) The client missing the packet can request a client of the same group to resupply the packet, thus guaranteeing integrity of the downloaded content of the client, and easing dependence on the source at same time. 4) Activities on network rely on the control data set, which is highly safe.

Characteristics and advantages of the present invention will be described in detail with reference to embodiments and attached drawings.

### BRIEF DESCRIPTION OF THE DRAWINGS

The present invention will be further explained with reference to drawings and embodiments.

FIG. 1 is a block diagram illustrating a system structure, in accordance with an embodiment of the invention.

FIG. 2 is a block diagram illustrating the data transmission between the source and the client as well as between the clients, in accordance with an embodiment of the invention.

FIG. 3 is a flow chart illustrating establishment and update of the control data set of the source, in accordance with an embodiment of the invention.

FIG. 4 is a flow chart illustrating the data block transmission, in accordance with an embodiment of the invention.

FIG. 5 is a flow chart illustrating a client receives content packets, in accordance with an embodiment of the invention.

### DETAILED DESCRIPTION OF THE INVENTION

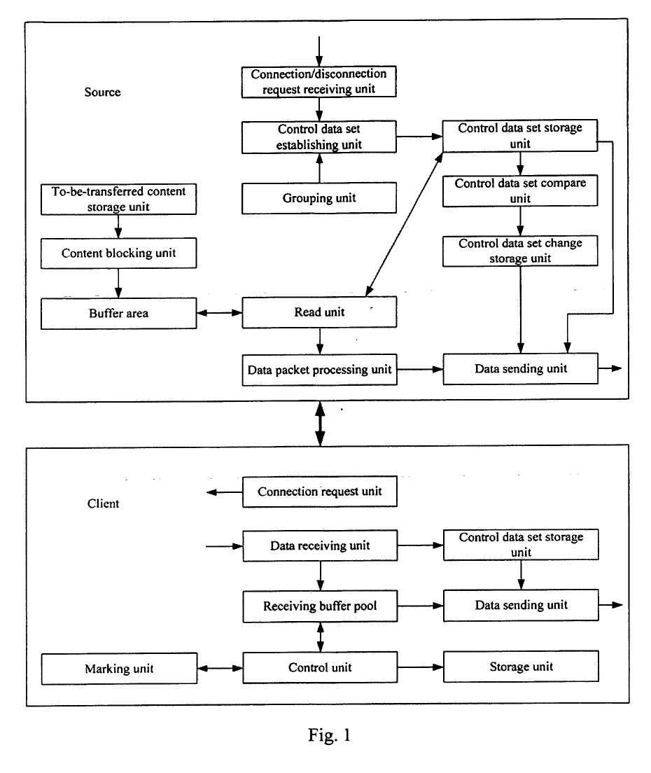

As shown in FIG. 1, the source includes a connection/disconnection request receiving unit, a control data set establishing unit, a control data set storage unit, a control data set compare unit, a control data set change storage unit, a grouping unit, a to-be-transferred content storage unit, a blocking unit, a buffer area, a reading unit, a data packet processing unit, and a data sending unit. The client includes a connection request unit, a data receiving unit, a control data set storage unit, a receiving buffer pool, a marking unit, a control unit, a storage unit, and a data sending unit.

The source has a control data set for the content to be transferred, the control data set including marks, control strategy, communication data of each client (such as IP addresses, ports, transmission quality, characteristics), etc. The client will send a transmission request to the source via the connection request unit when the client needs to receive the content. The source judges legality of the request, and adds the control data the client uses for transmission to the control data set of the source if the transmission is permitted, which is called a “connection” here. When the client is disconnected (actively or non-actively), the source deletes the client from the control data set, meaning leaving the content transmission. Each time the source establishes a new control data set, the new control data set will all be stored in the control data set storage unit, where (only) the latest several control data sets, Fi, . . . , Fn, will be stored. Each connection or disconnection of the client will result in change of the control data set of the source. Any change of the control data set of the source will all have to be remarked, so as to be distinct from the old marks, the changed control data set being marked according to its sequence of change. The n^{th} control data set is the latest one, and is marked as Fn. The control data set compare unit compares Fn with Fn−1, stores the changed part in the control data set change storage unit, and sends to each of the clients connected with the source via the data sending unit after the data packet assembly.

The above-mentioned control data set compare unit is optional. The latest control data set will then be transferred directly if there is no such a compare unit. Transmission of update of the control data set is not limited to a specific way. It can be transferred in a C/S way, a distribution-tree way, or a P2P way, etc.

The source performs initialization first when the client requests connection, and checks legality of the client. Only a legal client can then enter the control data set. The initialization further includes the source transferring the control data set to the client.

When the client requests the source for connection, the request can be presented and returned to the control data set according to the UDP protocol, making the communication link through.

The client, after receiving the changed part of the control data set via the data receiving unit, updates the control data set stored in the control data set storage unit to the latest. For each connection or disconnection of the client, the grouping unit of the source divides the clients according to the control strategy into M groups (M=1, 2, . . . , the number of the clients connected), each containing N clients (N=1, 2, . . . , the number of the clients connected). There are approximately M*N clients. This division is rough, and the difference between the actual number and M*N can be offset with a null client. Change of the control strategy is also reflected on the control data set. Therein M and N are natural numbers bigger than 1.

The blocking unit of the source divides content to be transferred into the blocks. The longest length of the block is optional, but a length suitable for the Internet UDP protocol transmission is preferred, e.g. (1460—additional packet assembly bytes) bytes. The divided blocks are added with additional information, including content mark, block number, time slice, check sum, etc. The content mark is used for identifying different transferred content. The block numbers are continuous and ordered, according to which can position of the content of the block be judged. Assemble the packet, and put it in the buffer area to wait for transmission.

The data packets are stored in the waiting-for-transmission buffer area in a queue manner. A new packet will replace the oldest packet when the buffer area is full.

Circularly, the reading unit of the source, according to the number of groups, M, of the clients in the latest control data set, reads the M packets in the waiting-for-transmission buffer area. The data packet processing unit divides the M packets into M groups (making each packet as a group), the M packets being marked with the group numbers in one-to-one correspondence with the M groups, the group numbers of the M packets being 1 to M, respectively. The M packets are outputted to the data sending unit. The data sending unit, according to such communication addresses as group numbers of the client in the latest control data set, IP addresses and ports, correspondingly transfers the M content packets to each member of the M groups according to the group numbers. The source transfers M content packets each time, such that each of the clients receives directly and only receives from the source one content packet having this group number (with the exception of special circumstances, e.g. resupplying). For example, each client of Group K (there are N clients in Group K) receives the K^{th} content packet marked with the group number of Group K. The content packet is added with the mark Fn, the time slice of the control data set, etc., at the same time of transmission.

The client, after receiving the content packet, places the received content packet in the receiving buffer pool, where the content packets are stored in a queue manner. A new packet will replace the oldest packet when the buffer pool is full.

After the client receives the content packet, the control unit detects the location where the content packet is placed in the receiving buffer pool, and the marking unit makes a having-received mark at a corresponding position, and records the position in the receiving buffer pool.

Each time a position is marked in the marking unit, the control unit will check the content packet mark table in the marking unit, judge whether the received content packet is continuous, and store the continuous content packet (i.e. the received content) to the storage unit or use it.

The source relies on the control data set to transfer content to the client. The clients also rely on the control data set to perform mutual communication, content forwarding and content resupplying, and further to transfer some private information. All the content can be controlled to transfer only between the source and the clients in the control data set, and thus the transferred content can be protected.

When the client receives the content packet, the data sending unit, according to the latest control data set in the control data set storage unit, forwards to the corresponding members in other groups in accordance with the group the client belongs to and the members as well as the specific setting. For example, Member i of Group K forwards the K-group content packets to Member i of non-Group K. When there is a null member in a certain group (a null member exists when the actual number of members in the group is smaller than N), the source can be selected to be responsible for transmission of the content packet to be forwarded.

The client can periodically send the transmission quality data to the source, which is used at same time as an indication of the client being alive.

The control strategy includes the following: When transmission quality of the client exceeds a set parameter scope, the client can be controlled to exit from this content transmission, and switch to another group of content communication with different quality, or be treated as disconnection.

The control data set further points out how to forward between different groups, as well as which client in the group is responsible to for resupplying the content. The selection scope of M and N is preset, and can be either a group of scopes or a multiple groups, so as to be further selected under different conditions. For example, one of the groups is set as below:

A1) The source is responsible for resupplying the content when N=1.

A2) N>1 when the client is responsible for resupplying the content.

A3) By setting processing t-second content each time and a transmission rate of s (bytes/second), the following is obtained:

M0=s*t/size of the content packet (bytes)

M is no bigger than M0 when the number of the clients connected is bigger than M0

A4) When A2 and A3 are satisfied, make M*N close to the number of the clients connected as far as possible.

The content can be selected from audio/video data, computer files, data storage blocks and UDP data packets on network.

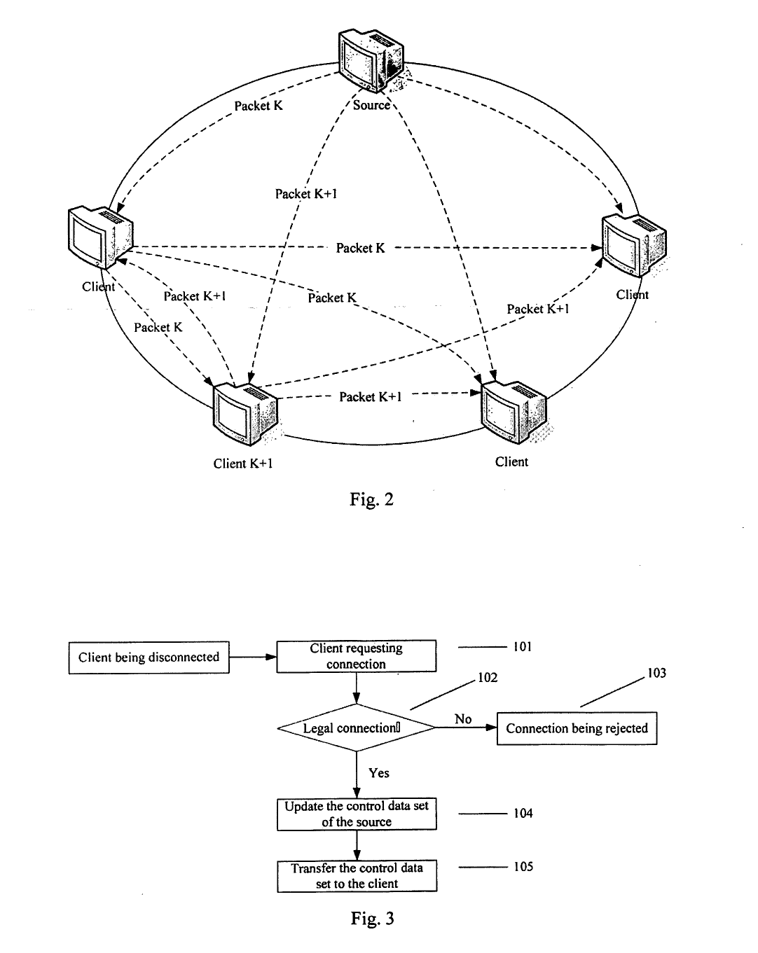

FIG. 2 is a schematic drawing of the data transmission between the source and the client or between clients of different groups.

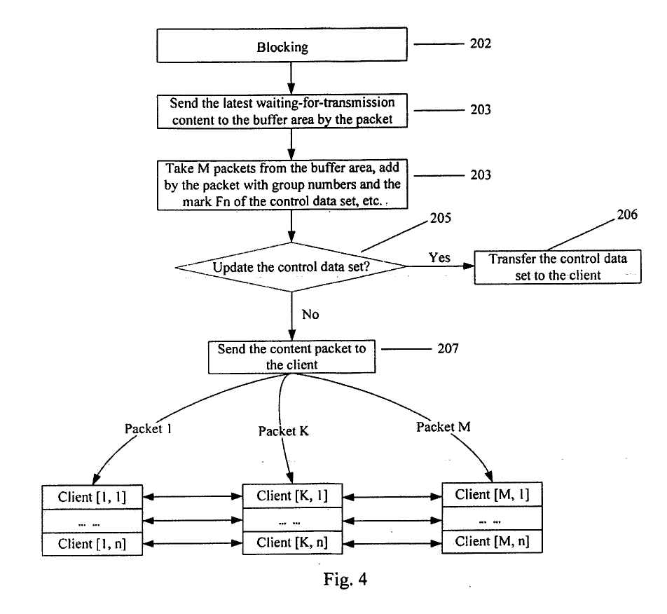

FIG. 3 shows a flow chart of establishment and update of the control data set, which includes the following steps:

In Step 101, the source receives a connection request from the client or the client is disconnected. Step 104 is directly executed when the client is disconnected. Step 102 is executed when the client requests connection.

In Step 102, the source judges whether the connection request of the client is legal. Step 104 will be executed if it is legal, and Step 103 will be executed if it is not, with the connection being rejected.

In Step 104, the source updates the control data set of the source according to connection and disconnection of the client. Then Step 105 is executed.

In Step 105, the source transfers the latest control data set to each of the clients connected with the source. The source has to transfer the control data set to each of the clients connected, and tries to keep the control data set of the client consistent with the source before the content transmission. The control data set can be transferred directly to the entire control data set. It is preferred to only transfer the change after comparing the latest control data set to the previous one. There are many transmission methods for transferring only the change part, which include the following steps:

1. For the continuous data, the source continuously extracts the data set according to a set time interval, and marks according to the extraction sequence, this mark being unique and continuous;

2. the source compares the integral set of the latest data set with that of its previous data set by the symbols, and obtains a variation string;

3. a variation set is obtained after transformation and the corresponding marking of the variation string; and

4. the variation set is transferred to the client, so that the client updates the data set to the latest one according to its current data set, and the latest data set is marked with the same mark with the latest data set of the source.

The “symbol” refers to byte, half word, word, double word, or any other binary number selected and improved in advance. For easy comprehension, here assume that the data are formed by a byte, which can be one or two bytes.

There is usually a small change in a certain duration for many dynamically changed data sets. The data set is divided into some symbols under a transmission mode where only the changed part is transferred. Because of high randomness of the symbol, its length can be one or two bytes, etc. An item may be divided into many symbols. The data sets are mutually compared taking the symbol as a unit, thus decreasing the compare unit. Therefore, the bytes of the obtained variation string are decreased in length, thus substantially reducing the transmission volume, increasing the transmission speed, and lowering the requirement for the bandwidth.

It is preferred to adopt a relative-position marking method, that is, each of the variation sets includes a starting mark, a new data set mark, an old data set mark, at least one variation string element, and an offset value of this variation string element relative to the starting position of the data set. The variation string element includes a variation string element head and the variation string, and the variation string element head includes a variation string head mark and the variation string length.

FIG. 4 shows a flow chart of the data block transmission, which includes the following steps:

In Step 202, the source divides the content to be transferred into the blocks with a proper length, and adds the additional information to the data block and pre-assembles the packet. Then Step 203 is executed.

In Step 203, the content packet is stored in the waiting-for-transmission buffer area in a queue manner. Then Step 204 is executed.

In Step 204, the source takes out M content packets from the buffer area each time, and marks each of the content packets with the corresponding group number, the mark Fn of the control data set, time slice, etc. Step 205 is executed after the packet assembly.

In Step 205, the source checks whether there is an updated control data set. Step 206 will be executed if there is, and the control data set is first transferred to each of the clients. Step 207 will be executed if there is not.

In Step 207, the source sends the M content packets to each of the clients of the M groups, respectively, according to the group number of the client in the control data set as well as IP address and port of the client.

In Step 208, each group of the clients all receives the content packet, the clients of the same group receiving the same content packets. Different groups, according to such communication data as the group number of the client in the control data set, IP addresses and ports, send actively the content packet they receive from the source to the client of a different group, and will not forward the content packet when the client in correspondence with it in a different group is null. Or the client having received the content packet, according to the client group in the latest control data set and the communication data of the client, actively forwards the received content packet to a client of another group in a distribution-tree way. Through the content packet exchange between the clients of different groups, each of the clients can receive all the content packets, and composes the integral content.

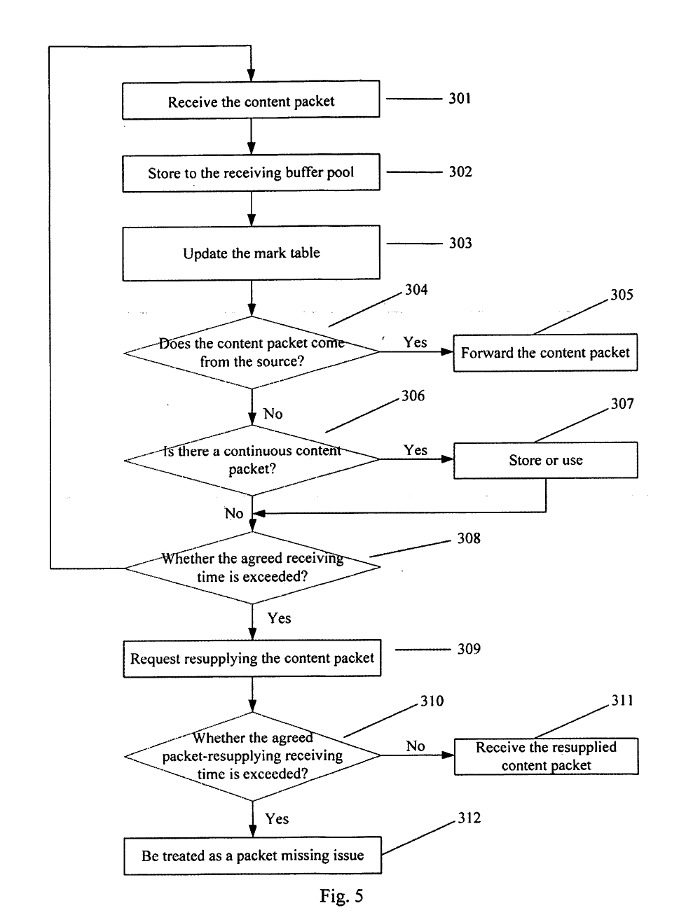

FIG. 5 shows a flow chart of the client receiving the content packet, which includes the following steps:

In Step 301, the client receives the content packet from the source or a client of different groups. Then Step 302 is executed.

In Step 302, the client stores the received content packet in the receiving buffer pool. Then Step 303 is executed.

In Step 303, the client updates the mark table in the marking unit, makes a having-received mark at a corresponding position in the mark table, and records the position in the receiving buffer pool. Then Step 304 is executed.

In Step 304, a judgment is made whether this received content packet is from the source. Step 305 will be executed if it is, and this content packet is actively forwarded to a corresponding client of different groups. Step 306 will be executed if it is not.

In Step 306, a judgment is made whether the received content in the mark table is continuous. Step 307 will be executed if it is, and the continuous content packet is stored to the storage unit or used. Then Step 308 is executed. Step 308 will be executed if it is not.

In Step 308, a judgment is made whether the agreed receiving time is exceeded. Step 301 will be executed if it is not, and the content packet is kept on being received. Step 309 will be executed if the content packet has not yet been received when the agreed receiving time is exceeded.

In Step 309, it is requested to resupply the missed content packet for the clients of the same group. When there is only one client or resupplying the content packet is failed, the client requests the source to resupply the missed content packet. Then Step 310 is executed.

In Step 310, a judgment is made whether an agreed packet-resupplying receiving time is exceeded. Step 311 will be executed if it is not, and the resupplied content packet is kept on being waited for. Step 312 will be executed if the resupplied content packet has not yet been received when the agreed packet-resupplying receiving time is exceeded, which is treated as a packet missing issue.

In the present invention, only after successful connection of the client with the source, can the client communicate with the source or other clients. That is, only the client registered in the control data set and the source can mutually transfer the content correctly, thus guaranteeing safety of the content transmission.

The source of the present invention can be either a server or two or more servers. For example, one of the servers is a management server, while another a content storage server.

The above-mentioned modules or processes can be programmed into a program, which can be installed in a computer, including the server computer.

The program programmed with the above-mentioned modules or processes can be stored in an exterior readable storage medium, which can be a floppy disk, a CD-ROM, a hard disk, a tape recording medium, a semiconductor storage of IC card, or other optical recording media (e.g. DVD or PD) or magnetic recording media. A server system providing network connection can also be used as a readable medium for recording the program. Therein the source program and the client program can also be stored separately in the readable storage medium.

1. data block transmission method, comprising:
A1. monitoring connection request and disconnection of a client that is waiting for receiving the data, and establishing a control data set for the clients that request transferring the same content, said control data set including the data necessary for mutual communication between all the clients and marks reflecting change of the control data set;
B1. dividing the clients added into the control data set into M groups, each of said groups including at least one client, and the number of the clients in each group being made equal as far as possible, said M being a natural number equal to 1 or bigger than 1;
C1. sending the control data set to the client;
D1. dividing the content the client requests to transfer into the data blocks, and transferring the data blocks to the M-group clients, respectively; and
E1. composing the integral content according to the data block exchange between the control data sets by the M-group clients.

2. The data block transmission method according to claim 1, further comprising: when finding the client is requesting connection or disconnection, changing the control data set, re-marking the control data set, and transferring the changed control data set to the connected client.

3. The data block transmission method according to claim 2, wherein the changed control data set is marked according to its sequence of change, and the transmission of the control data set refers to transferring only the changed part of the control data set.

4. The data block transmission method according to claim 3, wherein the transmission of the changed part of the control data set comprises:
A2. extracting the data set according to a set time interval continuously for the continuous data, and marking the data set according to the extraction sequence;
B2. comparing the integral set of the latest data set with that of its previous data set by symbols, for obtaining a variation string;
C2. transforming the variation string and marking it correspondingly, for obtaining a variation set; and
D2. transferring the variation set to the client, so that the client updates the data set to the latest one according to its current data set, and marks the latest data set with the same mark with the latest data set of the source.

5. The data block transmission method according to claim 1, wherein the content block transmission as mentioned in Step D1 comprises:
D11. dividing the content to be transferred into the blocks with a proper length;
D12. adding extra-information to the data block, and assembling the packets before being placed in a buffer area to wait for transmission, said extra-information including content mark, block number, time slice and check sum; and
D13. taking out M content packets from the buffer area each time, marking the M content packets with the group numbers in one-to-one correspondence with the M groups, and then transferring the M content packets to all the clients in each of the groups according to the group number.

6. The data block transmission method according to claim 5, wherein the block numbers in Step D12 are continuous and ordered, according to which can position of the content of the block be judged.

7. The data block transmission method according to claim 1, wherein said data exchange between the M-group clients in Step E1 comprises:
after receiving the content packet, actively forwarding the received content packet to a client in correspondence with it in a different group according to the client group in the latest control data set and the communication data of the client, and not forwarding the content packet when the client in correspondence with which in a different group is null; or
after receiving the content packet, actively forwarding the received content packet to a client of another group in a distribution-tree way according to the client group in the latest control data set and the communication data of the client.

8. The data block transmission method according to claim 7, further comprising the packet resupplying step: not receiving the content packet in the time-out period of an agreed receiving time, sending a packet resupplying request to a certain client of the same group by the client waiting for the content packet according to the latest control data set, to require the client to resupply the missed content packet.

9. The data block transmission method according to claim 8, said packet resupplying step comprising:
after receiving the packet resupplying request, the client of the same group searching for the requested content packet after judging that the packet resupplying request is legal, and forwarding the missed content packet if it is found or tell the reason if not.

10. The data block transmission method according to claim 9, further comprising: requesting the source to resupply the missed content packet when there is only one client or resupplying the content packet is failed.

11. The data block transmission method according to claim 8, further comprising, after receiving the content packet:
placing the received content packet in the receiving buffer pool, where the content packets are stored in a queue manner;
recording a mark indicating that the content packet has been received at a corresponding position in a content packet mark table, and recording the position of this content packet in the receiving buffer pool; and
checking the content packet mark table continuously to judge whether the received content packet is continuous, and storing or using the continuous content packet.

12. The data block transmission method according to claim 10, wherein if the client has not yet received the content packet to be received in the time-out period of an agreed time, it will be treated as a packet missing issue.

13. The data block transmission method according to claim 10, wherein the source relies on the control data set to transfer the content to the client, and the clients also rely on the control data set to perform mutual communication, content forwarding and content resupplying.

14. The data block transmission method according to claim 1, wherein the source performs initialization first during connection of the client and checks legality of the client, and only a legal client can then enter the control data set, the initialization further including the source transferring the control data set to the client.

15. The data block transmission method according to claim 8, wherein the client periodically sends transmission quality data to the source, which is used at same time as an indication of the client being alive; the control data set further includes control strategy, which is that when transmission quality of the client exceeds a set parameter scope, the client can be controlled to exit from this content transmission, and switch to another group of content communication with different quality, or be treated as disconnection.

16. The data block transmission method according to claim 1, wherein the content includes audio/video data, computer files, or UDP data packets on network.

17. A data block transmission device, the device comprising:
connection/disconnection request unit adapted to monitor connection request and disconnection of the client waiting for receiving the data;
control data set establishing unit adapted to establish a control data set for the client that requests transferring the same content, the control data set including the data necessary for mutual communication between all the clients and marks reflecting change of the control data set, the control data set being updated according to connection/disconnection information of the client monitored by the connection/disconnection request unit;
control data set storage unit adapted to store the control data set;
grouping unit adapted to divide the clients added into the control data set into M groups, there being at least one client in each of the groups, the number of the clients in each group being made equal as far as possible, M being a natural number equal to 1 or bigger than 1;
blocking unit adapted to divide the content a client requests to transfer into many data blocks, and assembling the packets before the packets are placed in the buffer area to wait for transmission;
reading unit adapted to read the M data packets from the buffer area according to the number of groups, M, of the clients in the latest control data set;
data packet processing unit adapted to divide the M packets into M groups, the M packets being marked with the group numbers in one-to-one correspondence with the M groups; and
data sending unit adapted to correspondingly transfer the M content packets according to the group number to each of the M-group clients, respectively, according to the data necessary for mutual communication between the clients in the latest control data set, and further for transferring the control data set to each of the clients connected with the source.

18. The data block transmission device according to claim 17, further comprising control data set compare unit and control data set change storage unit, said control data set compare unit being adapted to comparing the current control data set with a certain previous control data set and storing the changed part in the control data set change storage unit.

19. A data block transmission system including a content source and a client, said source comprising:
connection/disconnection request unit adapted to monitor connection request and disconnection of the client waiting for receiving the data;
control data set establishing unit adapted to establish a control data set for the client that requests transferring the same content, the control data set including the data necessary for mutual communication between all the clients and marks reflecting change of the control data set, the control data set being updated according to connection/disconnection information of the client monitored by the connection/disconnection request unit;
control data set storage unit adapted to store the control data set;
grouping unit adapted to divide the clients added into the control data set into M groups, there being at least one client in each of the groups, the number of the clients in each group being made equal as far as possible, M being a natural number equal to 1 or bigger than 1;
blocking unit adapted to divide the content a client requests to transfer into many data blocks, and assembling the packets before the packets are placed in the buffer area to wait for transmission;
reading unit adapted to read the M data packets from the buffer area according to the number of groups, M, of the clients in the latest control data set;
data packet processing unit adapted to divide the M packets into M groups, the M packets being marked with the group numbers in one-to-one correspondence with the M groups; and
data sending unit adapted to correspondingly transferring the M content packets according to the group number to each of the M-group clients, respectively, according to the data necessary for mutual communication between the clients in the latest control data set, and further for transferring the control data set to each of the clients connected with the source;
said client comprising:
connection request unit adapted to send the connection request of the transferred content to the source;
data receiving unit adapted to receive the data from the source or other clients, the data including the content requested to be transferred and the control data set;
control data set storage unit adapted to store the control data set; and
data sending unit adapted to forward the content packet received by the group to a corresponding member of other groups according to the group the client belongs to and the members, in accordance with the latest control data set.

20. The data block transmission system according to claim 19, wherein said source further comprises control data set compare unit and control data set change storage unit, said control data set compare unit being adapted to compare the current control data set with a certain previous control data set, and store the changed part in the control data set change storage unit;
said client further comprises content packet buffer pool, marking unit, control unit and storage unit, said content packet buffer pool being adapted to temporarily store the content packet the client has received in a queue manner, said control unit being adapted to detect the location where the content packet is placed in the receiving buffer pool, said marking unit being adapted to make a having-received mark at a corresponding position and record the position in the receiving buffer pool; and whenever a position is marked, the control unit will check the content packet mark table in the marking unit, judge whether the received content packet is continuous, and store the continuous content packet to the storage unit or use it.

21. A computer-readable medium with a computer-executable program, wherein the program can realize the following functions through execution of the source computer for sending data:
monitoring connection request and disconnection of the client waiting for receiving the data continuously, and establishing a control data set for the clients that request transferring the same content, said control data set including the data necessary for mutual communication between all the clients and marks reflecting change of the control data set;
dividing the clients added into the control data set into M groups, each of said groups including at least one client, and the number of the clients in each group being made equal as far as possible, said M being a natural number equal to 1 or bigger than 1;
sending the control data set to the client; and
dividing the content a client requests to transfer into the data blocks, and transferring the data blocks to the M-group clients, respectively;
the program can realize the following function through execution of the client computer:
composing the integral content according to the data block exchange between the control data sets after receiving the data block by the M-group clients.

22. The computer-readable medium according to claim 21, wherein the program can further realize the following functions through execution of the source computer:
dividing the content to be transferred into the blocks with a proper length;
adding extra-information to the data block, and assembling the packets before being placed in a buffer area to wait for transmission, said extra-information including content mark, block number, time slice and check sum; and
taking out M content packets from the buffer area each time, marking the M content packets with the group numbers in one-to-one correspondence with the M groups, and then transferring the M content packets to all the clients in each of the groups according to the group number.

23. The computer-readable medium according to claim 22, wherein the program can further realize the following functions through execution of the client computer:
after receiving the content packet, actively forwarding the received content packet to a client in correspondence with it in a different group according to the client group in the latest control data set and the communication data of the client, and not forwarding the content packet when the client in correspondence with which in a different group is null; or
the receiving the content packet, actively forwarding the received content packet to a client of another group in a distribution-tree way according to the client group in the latest control data set and the communication data of the client.

24. The computer-readable medium according to claim 23, wherein the program can further realize the following function through execution of the client computer:
not receiving the content packet in the time-out period of an agreed receiving time, sending a packet resupplying request to a certain client of the same group by the client waiting for the content packet according to the latest control data set, to require the client to resupply the missed content packet.
